(19) United States
(12) Patent Application Publication
(10) Pub. No.: US 2026/0172924 A1
(43) Pub. Date: Jun. 18, 2026

(54) HOME APPLIANCE, SYSTEM AND METHOD OF OPERATING HOME APPLIANCE

(71) Applicant: LG ELECTRONICS INC., Seoul (KR)

(72) Inventors: Cheolsook LEE, Seoul (KR); Dongjin SEO, Seoul (KR); Heungseop SIM, Seoul (KR); Suhwan LEE, Seoul (KR)

(73) Assignee: LG ELECTRONICS INC., Seoul (KR)

(21) Appl. No.: 19/423,734

(22) Filed: Dec. 17, 2025

(30) Foreign Application Priority Data
Dec. 17, 2024 (WO) PCT/KR2024/097046

(51) Int. Cl. H04W 36/00; H04W 60/04; H04W 76/14

(52) U.S. Cl. CPC H04W 36/035; H04W 60/04; H04W 76/14

(57) ABSTRACT

A home appliance according to an embodiment of the present disclosure may comprise a communication interface configured to communicate with a user terminal and a server; and a processor configured to: receive a network change request including network change information from the user terminal, register the network change information based on the network change request, transmit a device search list for peripheral home appliances to the user terminal, receive a network change command for at least one or more peripheral devices included in the device search list from the server, and transmit a network change request including the network change information to the at least one or more peripheral home appliances according to the received network change command.

### CROSS-REFERENCE TO RELATED APPLICATION

Pursuant to 35 U.S.C. § 119, this application claims the benefit of earlier filing date and right of priority to International Application No. PCT/KR2024/097046, filed on Dec. 17, 2024, the contents of which are all incorporated by reference herein in their entirety.

### BACKGROUND OF THE INVENTION

### 1. Field of the Invention

This disclosure relates to a method for collectively changing a network.

### 2. Discussion of the Related Art

Recently, with the popularization of a mobile terminal such as a smartphone and the development of IoT (internet of things) technology, the spread of a home appliance with communication function is increasing.

The home appliance equipped with communication function may be connected to a server or the mobile terminal through an access point (AP), such as a router in the home.

Additionally, a user may conveniently check the status of home appliance through the mobile terminal such as a phone, and may also remotely control the operation of home appliance. Furthermore, the user may easily perform product registration for the home appliance through the mobile terminal.

However, in the past, in order to change the network information of the home appliance, the phone was directly connected to the home appliance, the user input the changed network information through the phone, and the changed network information was transmitted to each of a plurality of home appliances one by one.

Accordingly, a problem may arise in which the overall time required for network setup of all home appliances becomes longer.

In addition, the connection mode setting method for each home appliance is different (some devices are registered with a remote control, others are registered with a QR code, etc.), so changes may not be possible, causing inconvenience and raising concern about product quality issue.

### SUMMARY OF THE INVENTION

The present disclosure may be intended to collectively change the network settings of a plurality of home appliances when the network is changed.

The present disclosure may be intended to automatically change the network settings of the plurality of home appliances when the network is changed.

The present disclosure may be intended to automatically change the network settings of the plurality of home appliances sequentially based on a usage status of the home appliances when the network is changed.

A home appliance according to an embodiment of the present disclosure may comprise a communication interface configured to communicate with a user terminal and a server; and a processor configured to: receive a network change request including network change information from the user terminal, register the network change information based on the network change request, transmit a device search list for peripheral home appliances to the user terminal, receive a network change command for at least one or more peripheral devices included in the device search list from the server, and transmit a network change request including the network change information to the at least one or more peripheral home appliances according to the received network change command.

A system according to an embodiment of the present disclosure may comprise a user terminal; a server; and a home appliance, wherein the home appliance is configured to receive a network change request including network change information from the user terminal, register the network change information based on the network change request, and transmit a device search list for peripheral home appliances to the user terminal, wherein the user terminal is configured to select at least one peripheral device included in the device search list as an automatic network change target, and transmit information on the selected at least one peripheral device to the server, wherein the server is configured to transmit a network change command for the selected at least one peripheral device to the home appliance, wherein the home appliance is further configured to: transmit the network change information to the at least one peripheral device according to a received network change command.

A method of operating a home appliance according to an embodiment of the present disclosure may comprise receiving a network change request including network change information from a user terminal; registering the network change information based on the network change request; transmitting a device search list for peripheral home appliances to the user terminal; receiving a network change command for at least one peripheral device included in the device search list from a server; and transmitting a network change request including the network change information to the at least one peripheral home appliance according to the received network change command.

According to an embodiment of the present disclosure, when the network is changed, the network settings of the plurality of home appliances are changed at once, thereby reducing the time required for network settings.

According to an embodiment of the present disclosure, when the network is changed, the network settings of the plurality of home appliances are automatically changed, so the user may conveniently change the network without repeating the process.

According to an embodiment of the present disclosure, when the network is changed, the network change may be quickly set starting from the home appliance that the user frequently uses.

### BRIEF DESCRIPTION OF THE DRAWINGS

FIG. 1 shows a block diagram of the configuration of a system according to an embodiment of the present disclosure.

FIG. 2 is a block diagram for explaining the configuration of a home appliance according to an embodiment of the present disclosure.

FIG. 3 is a block diagram for explaining the configuration of a user terminal according to an embodiment of the present disclosure.

FIG. 4 is a block diagram for explaining the configuration of a server according to an embodiment of the present disclosure.

FIGS. 5A and 5B are diagrams for explaining a method of changing the network of a system according to the prior art.

FIG. 6 is a sequence diagram for explaining a method of changing the network of a system according to an embodiment of the present disclosure.

FIGS. 7A to 7D are diagrams illustrating a process for selecting an automatic change target list according to an embodiment of the present disclosure.

FIGS. 8A and 8B are diagrams illustrating screens related to batch network change according to an embodiment of the present disclosure.

FIGS. 9 to 11 are diagrams illustrating a process of restoring a network connection of a failed home appliance through an existing network-connected home appliance when a user fails to connect the home appliance to a network according to an embodiment of the present disclosure.

### DETAILED DESCRIPTION OF THE PREFERRED EMBODIMENTS

Hereinafter, embodiments related to the present invention will be described in more detail with reference to the drawings. The suffixes “module” and “part” for components used in the following description are given or used interchangeably only for the ease of preparing the specification, and do not have distinct meanings or roles in themselves.

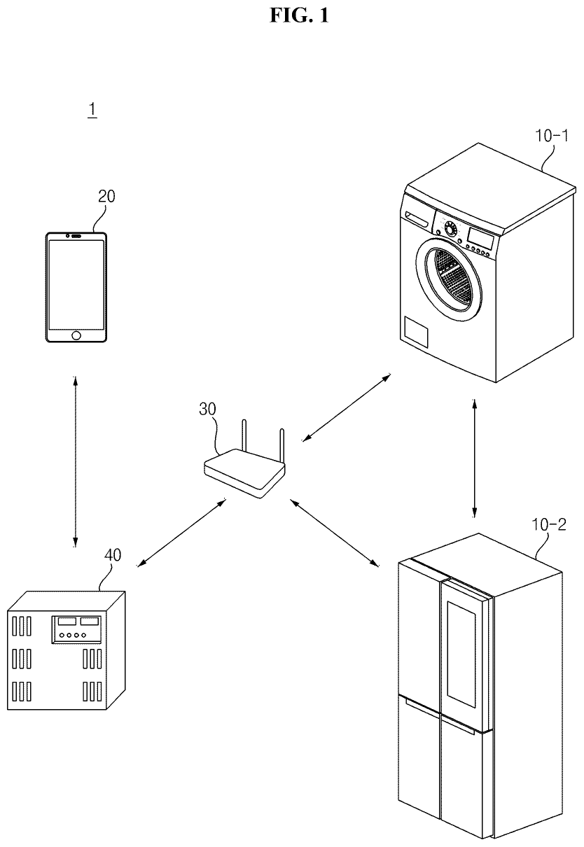

FIG. 1 shows a block diagram of the configuration of a system according to an embodiment of the present disclosure.

Referring to FIG. 1, the system 1 may include a plurality of home appliances 10-1 and 10-2, a user terminal 20, an access point 30, and a server 40.

The system 1 may provide a service for remotely controlling a plurality of home appliances 10-1 and 10-2 in the home through the user terminal 20.

Each of the plurality of home appliances 10-1 and 10-2 may be a device that is placed within a home or building and performs various operations. The home appliance may be any one of a refrigerator, a washing machine, an air purifier, a water purifier, or an air conditioner.

In FIG. 1, there are two home appliances as an example, but there is no need to be limited thereto and two or more home appliances may be provided.

The user terminal 20 may include a mobile terminal that the user may carry while moving, such as a smartphone, a tablet PC, a smart watch, a smart glass, etc., or a fixed terminal such as a PC.

The access point 30 may connect the plurality of home appliances 10-1 and 10-2 to the server 40. For example, the plurality of home appliances 10-1 and 10-2 may include a Wi-Fi circuit that supports Wi-Fi wireless communication and be connected to the access point 30 through the Wi-Fi circuit.

The access point 30 may be referred to as a router.

The server 40 is a device that provides home appliance management service and may be managed by a manufacturer or a service provider. The server 40 may store information about each user who uses the home appliance management service. For example, the information on each user may include a user account, information on the user terminal 20, information on the access point 30, information on registered home appliances, etc.

When the server 40 receives a control command for a specific home appliance from the user terminal 20, the received control command may be transmitted to the corresponding home appliance through the access point 30. The corresponding home appliance 10 may operate based on the received control command.

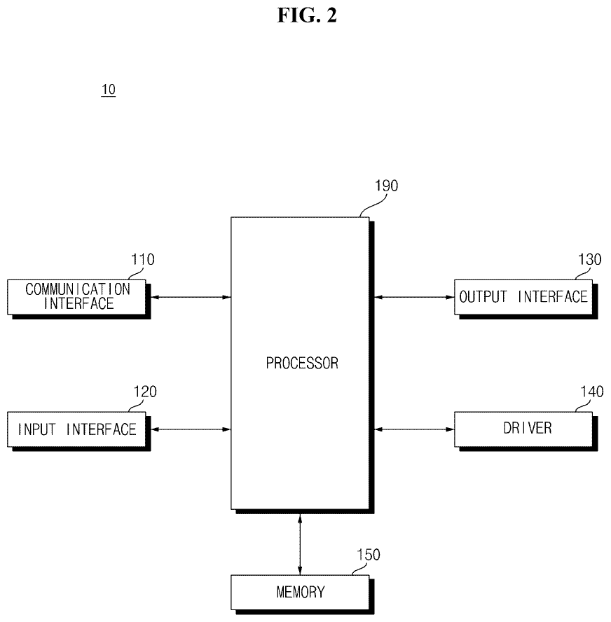

FIG. 2 is a block diagram for explaining the configuration of a home appliance according to an embodiment of the present disclosure.

Referring to FIG. 2, the home appliance 10 may include a communication interface 110, an input interface 120, an output interface 130, a driver 140, a memory 150, and a processor 190.

The communication interface 110 may transmit and receive data with external devices such as other home appliances, the user terminal 20, the access point 30, and the server 40 using a wired and a wireless communication technology.

The input interface 120 may include a camera for inputting a video signal, a microphone for receiving an audio signal, and a user input interface for receiving information from a user.

The output interface 130 may output information. The output interface 130 may include a display that displays the video signal and a speaker that outputs the audio signal.

The driving unit 140 may include elements for performing operations related to functions provided by the home appliance 10. For example, when the home appliance 10 is a washing machine, the driving unit 140 may include a drum motor, a water supply device, etc.

The memory 150 may store various software and data related to the operation of the home appliance 10.

The processor 190 may control the overall operation of the home appliance 10.

When a linkage with an external device is necessary to perform the operation of the home appliance 10, the processor 190 may generate a control signal for controlling the external device and transmit the generated control signal to the external device.

The processor 190 may control at least some of the components of the home appliance 10 to run the application program stored in the memory 150.

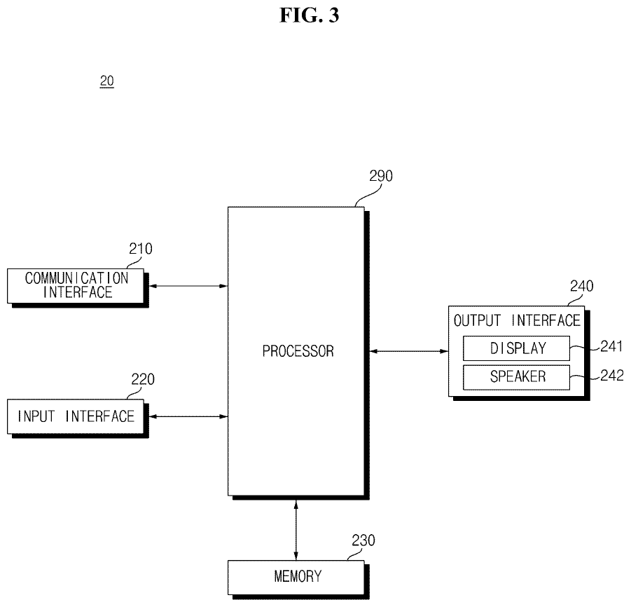

FIG. 3 is a block diagram for explaining the configuration of a user terminal according to an embodiment of the present disclosure.

Referring to FIG. 3, the user terminal 20 may include a communication circuit 210, an input interface 220, a memory 230, an output interface 240, and a processor 290.

The user terminal 20 may be implemented as a fixed or movable device, such as a projector, a mobile phone, a smartphone, a desktop computer, a laptop, a digital broadcasting terminal, a personal digital assistants (PDA), a portable multimedia player (PMP), a navigation, a tablet PC, a wearable device, a set-top box (STB), a DMB receiver, a radio, or a desktop computer.

The user terminal 20 may include a communication circuit 210, an input interface 220, a memory 230, an output interface 240, and a processor 290.

The communication circuit 210 may transmit and receive data with external devices such as other user terminals or servers using a wired or a wireless communication technology.

The communication circuit 210 may perform a communication using one communication standard among GSM (Global System for Mobile communication), CDMA (Code Division Multi Access), LTE (Long Term Evolution), 5G, WLAN (Wireless LAN), Wi-Fi (Wireless-Fidelity), Bluetooth, RFID (Radio Frequency Identification), Infrared Data Association (IrDA), ZigBee, and NFC (Near Field Communication).

The input interface 220 may include a camera for inputting a video signal, a microphone for receiving an audio signal, and a user input interface for receiving information from a user.

Here, the camera or microphone may be treated as a sensor, and the signal obtained from the camera or microphone may be referred to as sensing data or sensor information.

The memory 230 may store various software and data related to the operation of the user terminal 20.

The output interface 240 may include a display 241 that displays an video signal received from the outside and a speaker 242 that outputs an audio signal.

The processor 290 may control the overall operation of the user terminal 20.

If a linkage with an external device is required to perform an operation of the user terminal 20, the processor 290 may generate a control signal to control the external device and transmit the generated control signal to the external device.

The processor 290 may control at least some of the components of the user terminal 20 to run an application program stored in the memory 230.

The processor 290 may operate two or more of the components included in the user terminal 20 in combination with each other in order to run the application program.

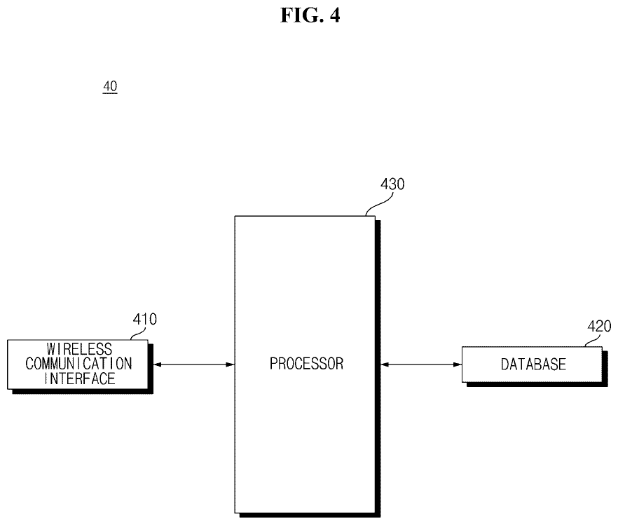

FIG. 4 is a block diagram for explaining the configuration of a server according to an embodiment of the present disclosure.

Referring to FIG. 4, a server 40 may include a wireless communication interface 410, a database 420, and a processor 430.

The wireless communication interface 410 may transmit and receive data with the user terminal 20 or home appliances 10-1 and 10-2 using a wireless communication technology. The wireless communication interface 410 may perform communication using any one of the communication standards of Long Term Evolution (LTE), 5G, Wireless LAN (WLAN), and Wireless-Fidelity (Wi-Fi).

The database 420 may store information on the user terminal 20, information on a plurality of home appliances 10-1 and 10-2, and information on the access point 30.

The information on the user terminal 20 may include information about a user account of the user terminal 20.

The information on each home appliance may include at least one of a name of the home appliance, a type of the home appliance, or an identifier of the home appliance.

The information on the access point 30 may include a SSID and a password of the access point 30.

The processor 430 may generally control the operation of the server 40. The processor 430 may transmit and receive data with the user terminal 20 through a home appliance management application installed on the user terminal 20.

The processor 430 may transmit a control command to the corresponding home appliance according to an operation command of the home appliance received from the user terminal 20 through the wireless communication interface 410.

Hereinafter, a router may be referred to as the access point.

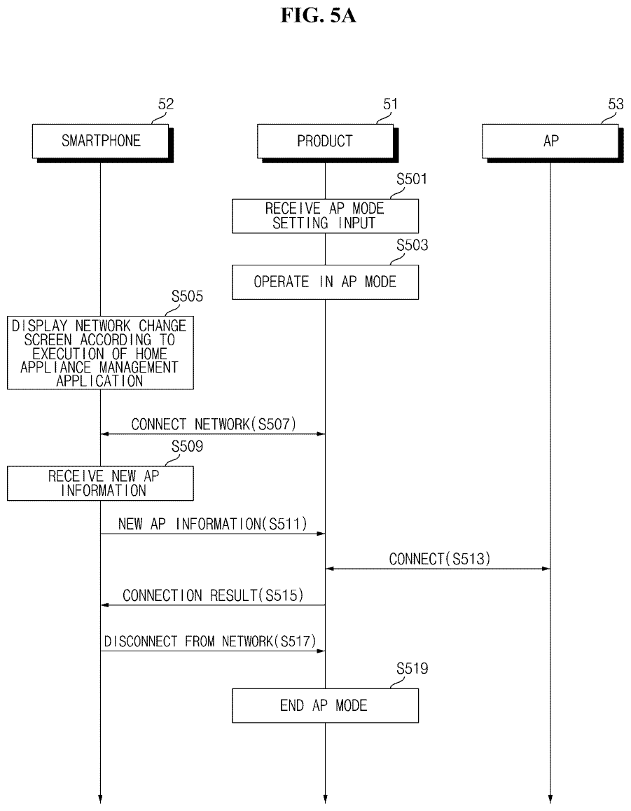

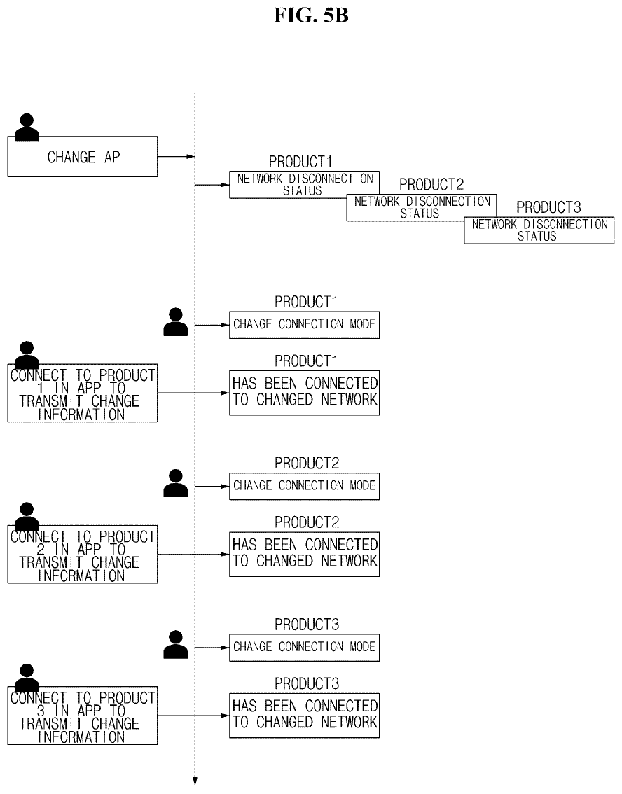

FIGS. 5A and 5B are diagrams for explaining a method of changing the network of a system according to the prior art.

Referring to FIG. 5A, the product 51 may receive an AP mode setting input for setting the AP (Access Point) mode (S501).

Connection modes of the product 51 may include an AP mode and a station mode.

The AP mode may be a mode in which a smartphone 52 and the product 51 establish a connection without an AP 53. The AP mode may be a mode in which a Wi-Fi circuit provided in the product 51 connects to a Wi-Fi circuit provided in the smartphone 52 to establish a connection between the product 51 and the smartphone 52.

The station mode may be a mode in which the smartphone 52 and the product 51 establish a connection through the AP 53. The station mode may be a mode in which the Wi-Fi circuit provided in the product 51 connects to the AP 53 to establish a connection between the product 51 and the smartphone 52.

The user may switch the connection mode of the product 51 to AP mode through a specific button provided on the product 51.

The product 51 may operate the connection mode as the AP mode according to an AP mode setting request from the smartphone 52 (S503).

Accordingly, the product 51 may be connected to the smartphone 52 without the AP 53.

The smartphone 52 may display a network change screen according to an execution of the home appliance management application (S505) and may be connected to the product 51 through WIFI/TCP (Transmission Control Protocol) (S507).

The home appliance management application may be an application for remotely controlling home appliances through the smartphone 52 and managing a status of the home appliances.

The smartphone 52 may receive new AP information through the network change screen (S509) and transmit the new AP information to the product 51 (S511).

The new AP information may include information on the access point that has changed due to replacement of the access point. The new AP information may include a service set identifier (SSID) to identify the AP 53 and a password required to connect to the AP 53.

The product 51 may connect to the AP 53 using the new AP information (S513).

The product 51 may transmit a connection result of the network connection with the new AP to the smartphone 52 (S515).

The connection result may include a result indicating either a successful connection to the AP 53 or a connection failure to the AP 53.

The smartphone 52 may disconnect from the network with the product 51 through AP mode (S517).

The smartphone 52 may transmit a network release request to end the AP mode to the product 51.

The product 51 ends the AP mode (S519).

The product 51 may terminate the AP mode according to a network release request received from the smartphone 52.

Referring to FIG. 5B, when products 1 to 3 are connected through an existing AP and then replaced with a new AP, actions that the user must perform are shown. Each of products 1 to 3 may be a type of product 51.

Referring to FIG. 5B, the user switches the connection mode of product 1 to the AP mode according to the procedure in FIG. 5A.

Afterwards, the user connects product 1 and the smartphone 52 through the home appliance management application installed on the smartphone 52 to change the information (change information) of the replaced access point. The product 1 is connected to a network that has changed according to the access point's information.

The user performs the same procedure for product 2 and product 3 to connect product 2 and product 3 to the changed network.

However, according to FIGS. 5A and 5B, when the access point is replaced, the user must make individual settings to change the network for each product, which increases the overall time required.

In addition, each product has a different connection mode setting method (some products use a remote control, others use a QR code scan), which causes problems such as not being able to change the network or causing inconvenience, which reduces the quality of the product.

An embodiment of the present disclosure seeks to provide a method of collectively changing the network of a plurality of home appliances when replacing the access point.

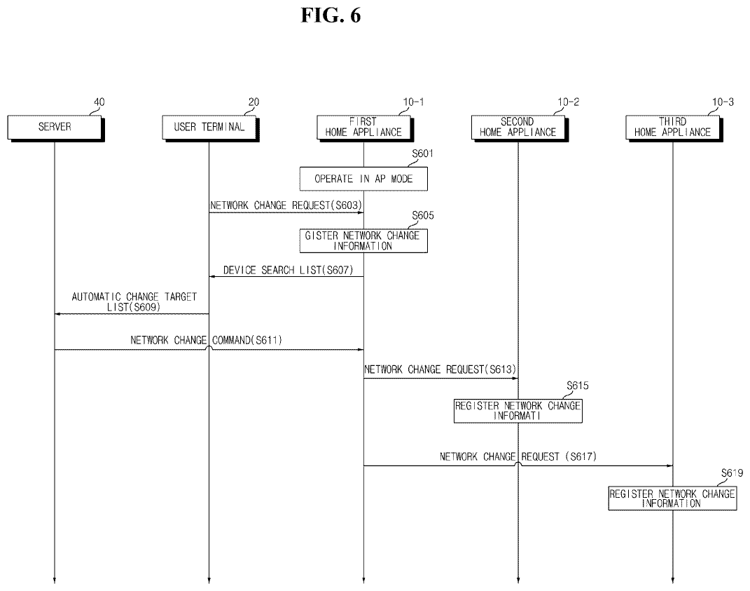

FIG. 6 is a sequence diagram for explaining a method of changing the network of a system according to an embodiment of the present disclosure.

Hereinafter, a batch network change may refer to the process of registering the plurality of home appliances to a new access point at once when replacing the access point.

Each of the first to third home appliances 10-1 to 10-3 may be an example of the home appliance 10 of FIG. 2.

Referring to FIG. 6, the processor 190 of the first home appliance 10-1 may operate the connection mode as the AP mode (S601).

In one embodiment, the processor 190 of the first home appliance 10-1 may operate the connection mode of the first home appliance 10-1 in the AP mode based on the user input received through the input interface 120. The processor 190 of the first home appliance 10-1 may switch the connection mode from the station mode to the AP mode based on the user input.

In another embodiment, the first home appliance 10-1 may operate the connection mode as the AP mode at the request of the user terminal 20.

The processor 290 of the user terminal 20 may transmit a network change request including network change information to the first home appliance 10-1 through the communication circuit 210 (S603).

The user terminal 20 may also operate in the AP mode and perform wireless communication with the first home appliance 10-1 under the AP mode. The wireless communication may be communication through the Wi-Fi standard, and for this purpose, the communication circuit 210 may include a Wi-Fi circuit.

The network change request may include information about the new access point. The information on the new access point may be referred to as the network change information.

The processor 190 of the first home appliance 10-1 may register the network change information for connection with the access point 30 to the new access point based on the network change request (S605).

The processor 190 of the first home appliance 10-1 may register the network change information in the new access point. Registering the network change information to the new access point may mean that the first home appliance device 10-1 completes a connection to the new access point using the network change information.

The first home appliance 10-1 may connect to the new access point by registering the network change information in the new access point.

The processor 190 of the first home appliance 10-1 may search for other peripheral home appliances and transmit a device search list including the searched home appliances to the user terminal 20 (S607).

For example, other peripheral home appliances may include the second home appliance 10-2 and the third home appliance 10-3. Each of the other peripheral home appliances may also be operated in the AP mode according to a user input or a request from the user terminal 20.

The processor 190 of the first home appliance 10-1 may search for the second home appliance 10-2 and the third home appliance 10-3 in the AP mode through the communication interface 110, and generate a device search result. The processor 190 of the first home appliance 10-1 may generate a device search list including items of the second home appliance 10-2 and the third home appliance 10-3 based on the generated device search result.

The device search result may include one or more of the name of the home appliance or the type of home appliance searched through the AP mode.

The processor 190 of the first home appliance 10-1 may transmit the device search list to the user terminal 20 through the communication interface 110.

The processor 290 of the user terminal 20 may transmit, to the server 40, an automatic change target list including home appliances that want to perform automatic change of the network based on the device search list received from the first home appliance 10-1 (S609).

The processor 290 of the user terminal 20 may display the device search list received from the first home appliance 10-1 on the display 241.

The processor 290 of the user terminal 20 may add home appliances that were not searched by the first home appliance 10-1 to the device search list, or display them separately from the device search list.

The processor 290 of the user terminal 20 may select home appliances for which the network is to be changed to a new access point through the user input, and transmit the automatic change target list including the selected home appliances to the server 40.

The processor 290 of the user terminal 20 may display a network change screen including the automatic change target list on the display 241 and receive an input of a network change target through the network change screen.

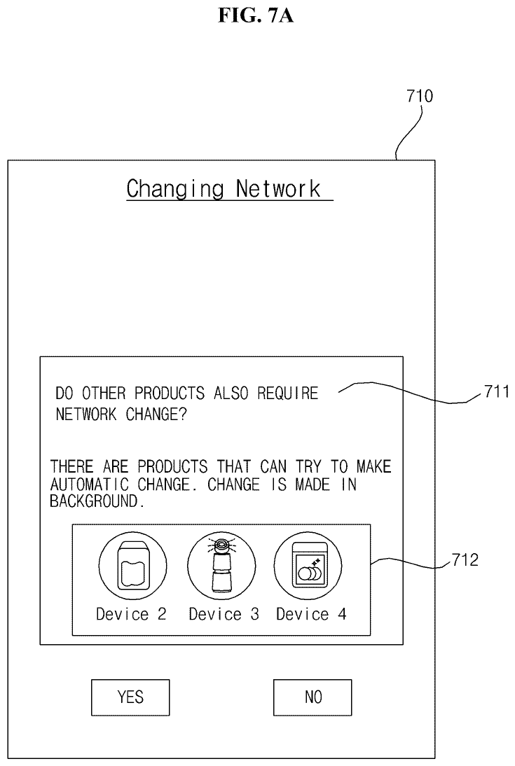

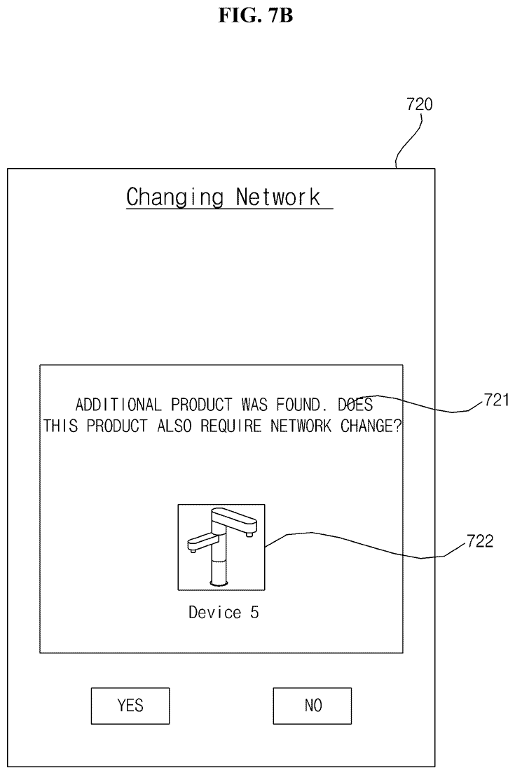

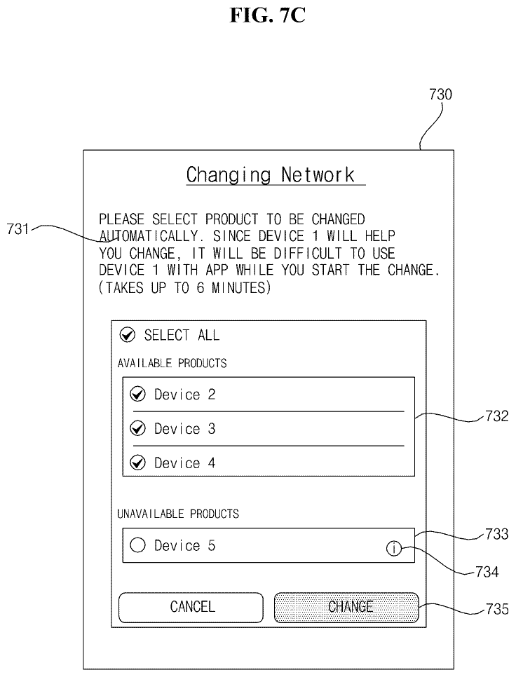

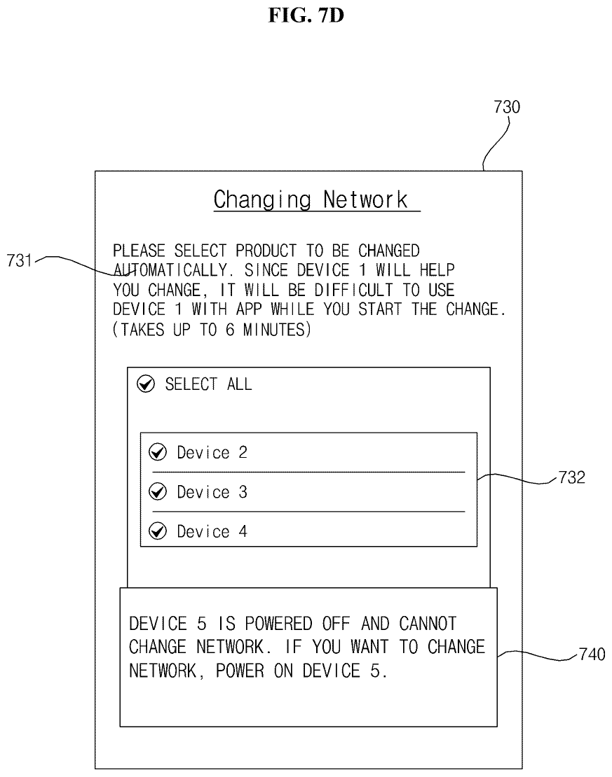

FIGS. 7A to 7D are diagrams illustrating a process for selecting an automatic change target list according to an embodiment of the present disclosure.

The network change screen described below may be a screen displayed as the home appliance management application is executed.

Referring to FIG. 7A, the processor 290 of the user terminal 20 may display a first network change screen 710 on the display 241 based on the device search list received from the first home appliance 10-1.

The processor 290 of the user terminal 20 may display the first network change screen 710 on the display 241 according to the execution of the home appliance management application.

The first network change screen 710 may include a text 711 inquiring whether a network change of a home appliance other than the first home appliance 10-1 is necessary and a device search list 712 received from the first home appliance 10-1. The first network change screen 710 may further include a text indicating that the network change is performed in a background.

The user terminal 20 may receive a user input for selecting one or more of the home appliance device items (device 2, device 3, device 4) included in the device search list 712.

Each home appliance item may include one or more of the name of the home appliance or an image representing the home appliance.

Each of the device 2, the device 3, and the device 4 may be the name or the type of each home appliance.

The user terminal 20 may transmit the automatic change target list including one or more home appliance items selected according to the received user input to the server 40.

The user may easily select home appliances for which the user want to change the network in batches through the first network change screen 710.

Referring to FIG. 7B, the processor 290 of the user terminal 20 may display, on the display 241, a second network change screen 720 for adding a home appliance previously registered in the server 40 to the network change target in addition to the device search list received from the first home appliance 10-1.

The second network change screen 720 may additionally include a text 721 indicating that a home appliance device has been searched and an additionally searched home appliance item 722 (device 5).

Additional searched home appliance may be provided by the server 40. The user terminal 20 may transmit the automatic change target list and the device search list to the server 40, and if the server 40 does not include a home appliance previously registered in the server 40 based on the device search list, information on the home appliance may be transmitted to the user terminal 20.

The user terminal 20 may provide a second network change screen 720 based on information about the corresponding home appliance received from the server 40. That is, when the server 40 does not include a home appliance previously registered in the server 40 based on the device search list, a notification including information about the home appliance may be transmitted to the mobile terminal 20.

As another example, the home appliance device item (device 5) additionally searched by the server 40 may be included in the device search list 712 of the first network change screen 710. Home appliance items searched by the first home appliance 10-1 and home appliance items additionally searched by the server 40 may be displayed separately from each other.

As such, according to an embodiment of the present disclosure, devices that are not searched by the first home appliance 10-1 are also searched, making it easy to change the network in batches.

Referring to FIG. 7C, the user terminal 20 may display a third network change screen 730 on the display 241 based on the device search list received from the first home appliance 10-1.

The third network change screen 730 may include a guide text 731, a first device list 732, and a second device list 733. The first device list 732 and the second device list 733 may be included in the device search list.

The guide text 731 may include a text indicating that the first home appliance 10-1 is used to change the network, so a use or a control of the first home appliance 10-1 is impossible through the home appliance management application.

The first home appliance 10-1 may receive an operation command for controlling the first home appliance 10-1 from the user terminal 20 during a network batch change operation of the searched home appliances. The first home appliance 10-1 may not perform an operation corresponding to the operation command before the network batch change operation. The first home appliance 10-1 may perform an operation corresponding to the operation command after the network batch change operation.

The first device list 732 may include home appliance device items that may be changed to a network with a new access point.

The second device list 733 may include home appliance device items that cannot be changed to a network with the new access point. The second device list 733 may further include an indicator 734 that may provide a reason for not being able to change the network.

The user terminal 20 may display a pop-up window 740 on the display 241 indicating a reason why the corresponding home appliance cannot change the network, as shown in FIG. 7D according to the user input of selecting the indicator 734.

The reason for not being able to change the network may be one of the following: the home appliance is turned off or a firmware of the home appliance is not updated, but this is only an example.

In this way, according to the embodiment of the present disclosure, when changing the network collectively, the reason why the network cannot be changed is provided, so the user may take appropriate an action accordingly.

FIG. 6 will be described again.

The processor 430 of the server 40 may transmit a network change command to the first home appliance 10-1 based on the automatic change target list received from the user terminal 20 (S611).

The first home appliance 10-1 may receive the network change command from the server 40 through a newly registered access point in the station mode.

The network change command may be a command to collectively perform network registration for the new access point. The network change command may include a network change target, network change information of the new access point, a network change order, and a command to register the network using the network change information.

The processor 430 of the server 40 may transmit the network change command to the first home appliance 10-1 through the new access point. This is because the first home appliance (10-1) is connected to the new access point.

The processor 430 of the server 40 may determine the network change order when there are a plurality of devices subject to network change. The processor 430 may determine the network change order based on at least one of a usage frequency of the home appliance or a usage time of the home appliance stored in the server 40.

The processor 430 may give a priority to the network change order of the home appliance as the usage frequency or the usage time of the home appliance increases.

The processor 430 may sum the usage frequency and the usage time of the home appliance, and assign higher priority to the network change order of the home appliance as a summed value increases.

The processor 190 of the first home appliance 10-1 may sequentially transmit the network change information to the corresponding home appliance according to the network change order.

The processor 190 of the first home appliance 10-1 may transmit the network change request including the network change information to the second home appliance 10-2 included in the automatic change target list according to the network change command received from the server 40 (S613).

The first home appliance 10-1 may communicate with each of the second home appliance 10-2 and the third home appliance 10-3 through the AP mode.

The second home appliance 10-2 may register the network change information according to the received network change request (S615).

The second home appliance 10-2 may complete the connection to the new access point using the network change information received from the first home appliance 10-1.

Likewise, the processor 190 of the first home appliance 10-1 may transmit a network change request including the network change information to the third home appliance 10-3 included in the automatic change target list according to the network change command received from the server 40 (S617).

The third home appliance 10-3 may register network change information according to the received network change request (S619).

The third home appliance 10-3 may complete a connection to the new access point using the network change information received from the first home appliance 10-1.

On the other hand, the home appliance that transmits the device search list to the mobile terminal 20 and receives a network change command from the server 40 may be a device placed at the center (for example, the first home appliance) among the plurality of home appliances (10-1, 10-2, 10-3) in the same space.

Each home appliance may measure a strength of a signal exchanged with each other under the AP mode. The device with the largest sum of the strength of each signal based on the measured signal may be a home appliance device that transmits the device search list to the mobile terminal 20 and receives the network change command from the server 40.

On the other hand, when the server 40 receives an operation command for controlling the first home appliance 10-1 from the mobile terminal 20 while the network batch change is in progress through the first home appliance 10-1, the network batch change may be performed and then transmit the operation command to the first home appliance 10-1.

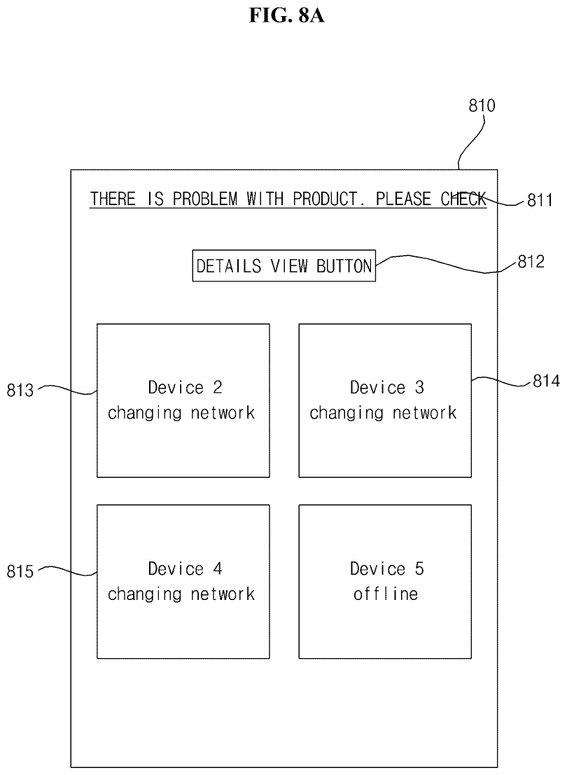

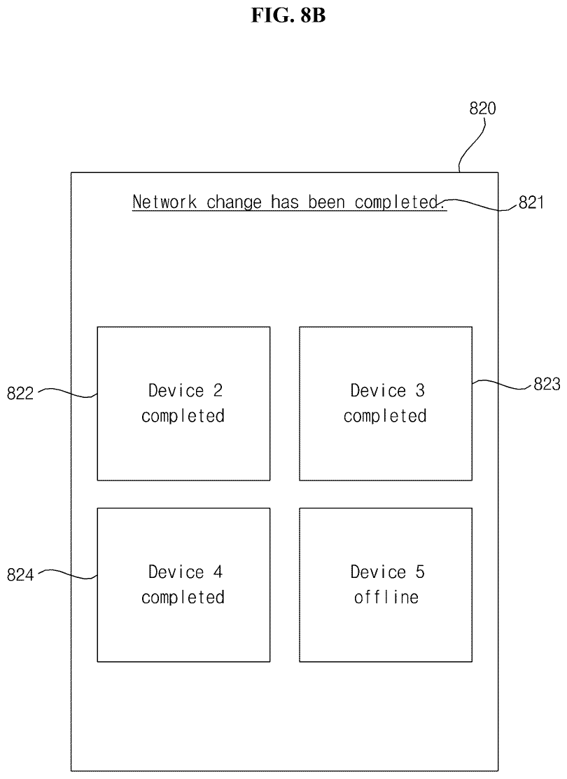

FIGS. 8A and 8B are diagrams illustrating screens related to batch network change according to an embodiment of the present disclosure.

Each screen may be a screen based on execution of the home appliance management application.

Referring to FIG. 8A, the user terminal 20 may display a network change progress screen 810 on the display 241 after transmitting the automatic target change list to the server 40.

The network change progress screen 810 may be a screen representing the network change progress of home appliances included in the automatic target change list.

If a problem occurs in the network change process, the network change progress screen 810 may include a text 811 indicating that a problem has occurred in the network change process and a details view button 812 to provide a reason for the problem.

The user terminal 20 may provide a reason for a problem in the network change process according to the user input of selecting the details button 812.

The network change progress screen 810 may further include device items 813, 814, and 815 indicating a state in which the network change is in progress.

Referring to FIG. 8B, the user terminal 20 may display a network change completion screen 820 on the display 241 after collectively changing the network.

The network change completion screen 820 may include a message 821 indicating that the network change has been completed and device items 822, 823, and 824 for which the network change has been completed.

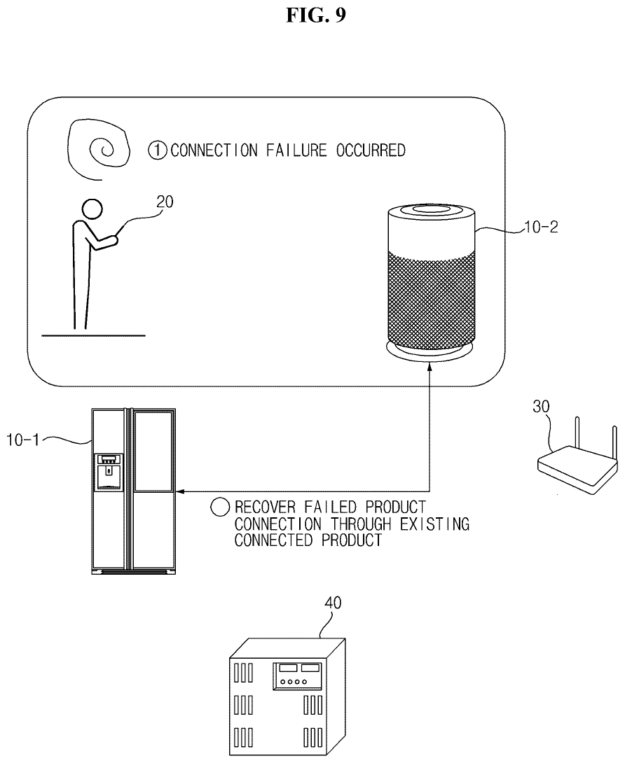

FIGS. 9 to 11 are diagrams illustrating a process of restoring a network connection of a failed home appliance through an existing network-connected home appliance when a user fails to connect the home appliance to a network according to an embodiment of the present disclosure.

Referring to FIG. 9, it is assumed that the first home appliance 10-1 is a device registered with the access point 30, and the second home appliance 10-2 is a device not registered with the access point 30. The access point 30 may be a new device that has been replaced.

The user may fail the process of registering the second home appliance 10-2 to the access point 30 through the user terminal 20. As an example, the user may perform the process of registering the second home appliance 10-2 with the access point 30 by scanning a QR code provided on the second home appliance 10-2 through the user terminal 20.

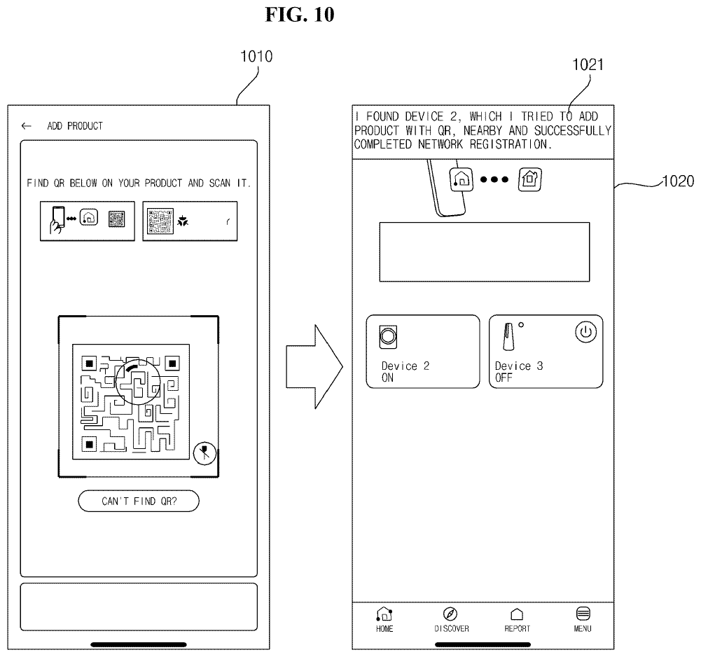

The user terminal 20 may display a QR scan screen 1010 through execution of the home appliance management application as shown in FIG. 10.

The server 40 may recognize that the user terminal 20 is connecting to the second home appliance 10-2 based on the QR scan screen 1010 of the home appliance management application. If a registration of the second home appliance 10-2 fails after a certain time, the server 40 may transmit a network registration command to the previously registered first home appliance 10-1.

The network registration command may be a command that causes the first home appliance 10-1 to transmit information about the access point 30 to the second home appliance 10-2. The network registration command may be the network change command.

The first home appliance 10-2 may transmit information on the access point 30 to the second home appliance 10-2 according to the network registration command received from the server 40. The second home appliance 10-2 may complete network registration based on the information of the access point 30.

As shown in FIG. 10, the user terminal 20 may display a notification 1021 indicating that network registration of the second home appliance 10-2 has been completed on the home screen 1020 of the home appliance management application.

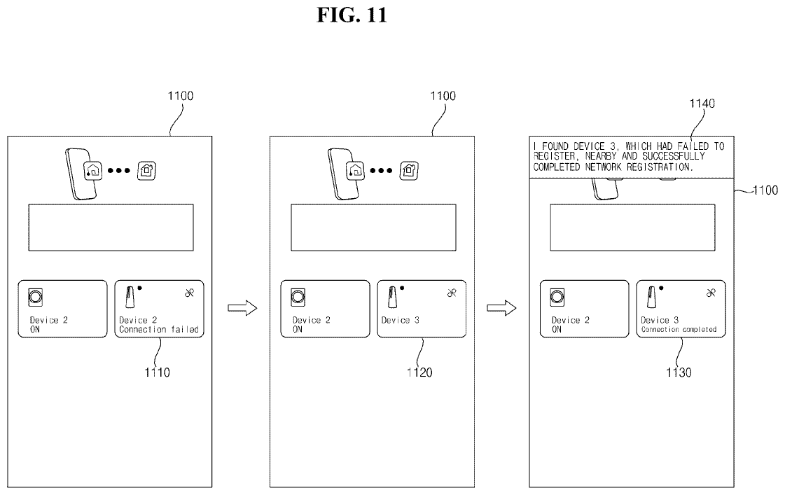

Referring to FIG. 11, the user terminal 20, if the network registration of the third home appliance 10-3 fails, may display a result of network registration failure on a device item 1110 corresponding to the 10-3 the third home appliance 10-3 included in the home screen 1100 of the home appliance management application.

Thereafter, the user terminal 20 may display on a device item 1120 that the third home appliance 10-3 is being registered through the pre-registered first home appliance 10-1 after 20 seconds to 1 minute.

Thereafter, the user terminal 20 may display a connection success result indicating that the registration has been completed on a device item 1130 when automatic registration of the third home appliance 10-3 is completed. Additionally, when automatic registration of the third home appliance 10-3 is completed, the user terminal 20 may display a notification 1140 indicating that the registration has been completed on the home screen 1100.

As such, according to an embodiment of the present disclosure, even if the user fails to connect the home appliance to the network, the home appliance that has failed to connect may be automatically registered through a pre-registered home appliance.

Accordingly, the user experience of the user's product registration process may be greatly improved.

According to an embodiment of the present invention, the above-described method may be implemented as processor-readable code on a program-recorded medium. Examples of media that the processor may read include ROM, RAM, CD-ROM, magnetic tape, floppy disk, and optical data storage device.

The device described above is not limited to the configuration and method of the above-described embodiments, and may be configured by selectively combining all or part of each embodiment so that various modifications may be made.

What is claimed is:

1. A home appliance, comprising:
a communication interface configured to communicate with a user terminal and a server; and
a processor configured to:
receive a network change request including network change information from the user terminal,
register the network change information based on the network change request,
transmit a device search list for peripheral home appliances to the user terminal,
receive a network change command for at least one or more peripheral devices included in the device search list from the server, and
transmit a network change request including the network change information to the at least one or more peripheral home appliances according to the received network change command.

2. The home appliance of claim 1, wherein the network change command is a command that performs a network registration for a new access point in batches.

3. The home appliance of claim 1, wherein the network change command further comprises a network change target and a network change order.

4. The home appliance of claim 3, wherein the processor is configured to:
sequentially, transmit the network change information to the at least one peripheral home appliance according to the network change order.

5. The home appliance of claim 1, wherein a connection mode of the home appliance includes an AP (Access Point) mode in which the home appliance establishes a connection with other device without an access point and a station mode in which the home appliance establishes a connection with other device through the access point.

6. The home appliance of claim 5, wherein the processor is further configured to:
search for the peripheral home appliances in the AP mode, and
obtain the device search list based on a search result.

7. The home appliance of claim 5, wherein the processor is configured to receive the network change command from the server in the station mode.

8. A system, comprising a user terminal; a server; and a home appliance,
wherein the home appliance is configured to:
receive a network change request including network change information from the user terminal, register the network change information based on the network change request, and transmit a device search list for peripheral home appliances to the user terminal,
wherein the user terminal is configured to:
select at least one peripheral device included in the device search list as an automatic network change target, and transmit information on the selected at least one peripheral device to the server,
wherein the server is configured to:
transmit a network change command for the selected at least one peripheral device to the home appliance,
wherein the home appliance is further configured to:
transmit the network change information to the at least one peripheral device according to a received network change command.

9. The system of claim 8, wherein the network change command is a command that performs a network registration for a new access point in batches.

10. The system of claim 9, wherein the network change command further comprises a network change target and a network change order.

11. The system of claim 10, wherein the home appliance is configured to:
sequentially, transmit the network change information to the at least one peripheral home appliance according to the network change order.

12. The system of claim 10, wherein the server is further configured to determine the network change order based on at least one of a usage frequency or a usage time of the home appliance.

13. The system of claim 8, wherein the server is further configured to:
when an operation command for controlling the home appliance is received from the user terminal during a network change of the at least one peripheral home appliance through the home appliance, transmit the operation command to the home appliance after changing the network of the at least one or more peripheral home appliances.

14. The system of claim 8, wherein the server is further configured to:
if there is a peripheral home appliance that is not included in the device search list, transmit a notification including information on the peripheral home appliance to the user terminal.

15. The system of claim 8, wherein the user terminal is further configured to display the device search list, and
wherein the device search list includes a device that can change the network and devices that cannot change the network.

16. The system of claim 15, wherein the user terminal is further configured to display a reason why the network cannot be changed.

17. The system of claim 8, wherein a connection mode of the home appliance includes an AP (Access Point) mode in which the home appliance establishes a connection with other devices without an access point and a station mode in which the home appliance establishes a connection with other device through the access point.

18. The system of claim 17, wherein the home appliance is further configured to:
search for the peripheral home appliances in the AP mode, and
obtain the device search list based on a search result.

19. The system of claim 17, wherein the home appliance is configured to receive the network change command from the server in the station mode.

20. A method of operating a home appliance, comprising:
receiving a network change request including network change information from a user terminal;
registering the network change information based on the network change request;
transmitting a device search list for peripheral home appliances to the user terminal;
receiving a network change command for at least one peripheral device included in the device search list from a server; and
transmitting a network change request including the network change information to the at least one peripheral home appliance according to the received network change command.
